(19) United States
(12) Patent Application Publication
(10) Pub. No.: US 2026/0208242 A1
(43) Pub. Date: Jul. 23, 2026

(54) METHOD FOR CLEANING A FLOWMETER

(71) Applicant: Endress+Hauser Flowtec AG, Reinach (CH)

(72) Inventors: Michael Wiesmann, Freising (DE); Alfred Rieder, Landshut (DE); Yaoying Lin, Freising (DE); Ute Finke, Starnberg (DE)

(21) Appl. No.: 19/142,374

(22) PCT Filed: Dec. 20, 2023
(86) PCT No.: PCT/EP2023/087136

§ 371 Date: Jun. 23, 2025

(30) Foreign Application Priority Data
Dec. 23, 2022 (DE) 10 2022 134 790.7

(51) Int. Cl. B08B 13/00; B08B 9/027; G01F 1/84; G01N 9/32

(52) U.S. Cl. CPC B08B 13/00; B08B 9/027; G01F 1/8422; G01F 1/8427; G01F 1/8477; G01F 1/849; G01N 9/32; B08B 2209/027

(57) ABSTRACT

The present disclosure relates to a method for cleaning a flowmeter comprising at least one oscillatory measurement tube, where the cleaning is performed in order to remove a coating from a wall of the at least one measurement tube. The method includes applying a cleaning medium to the measurement tube and repeatedly acquiring measurement values of a monitoring parameter which is dependent on the coating. The measurement values are acquired by means of the meter. A cleaning progress is determined on the basis of the measurement values of the monitoring parameter, and the cleaning process is controlled on the basis of the determined cleaning progress.

The invention relates to a method for cleaning a flowmeter comprising at least one oscillatory measurement tube.

Flowmeters are used in the process industry to acquire flow rates of process media. Depending on the process conditions, a plurality of process media can cause coatings to form in the measurement tubes of the meters, which can firstly lead to incorrect measurement values and secondly to clogged measurement tubes. In these cases, it is essential to regularly clean the meters and the measurement tubes thereof. During the necessary cleaning cycles, the meters are not available for their actual measurement tasks in process monitoring. The cleaning process should therefore be as thorough as possible, but at the same time as brief as possible in order to minimize downtime of the meters. In order to optimize the cleaning time, the results of previous cleaning cycles can be evaluated, assuming that the type and quantity of coatings to be removed does not change from one cleaning cycle to the next. In addition, the same cleaning procedures should always be used. However, these conditions are not always met. The object of the present invention is therefore to provide an optimized method for cleaning a flowmeter.

The object is achieved according to the invention by the method according to independent claim 1.

The method according to the invention relates to the cleaning of a flowmeter comprising at least one oscillatory measurement tube, wherein the cleaning is performed in order to remove a coating from a wall of the at least one measurement tube, wherein the method comprises: applying a cleaning medium to the measurement tube; repeatedly acquiring measurement values of a monitoring parameter which is dependent on the coating, wherein the measurement values are acquired by means of the meter; and determining a cleaning progress on the basis of the measurement values of the monitoring parameter.

In a development of the invention, determining the cleaning progress comprises: comparing the measurement values with at least one threshold value of the monitoring parameter; and/or comparing the temporal change of the measurement values with at least one threshold value.

In a development of the invention, the method further comprises: controlling the cleaning process on the basis of the determined cleaning progress.

In a development of the invention, controlling the cleaning process comprises: initiating a subsequent method step on the basis of the cleaning progress.

In a development of the invention, the subsequent method step comprises adjusting a cleaning process with regard to the process parameters thereof and/or terminating the cleaning process.

In a development of the invention, the method further comprises: verifying the cleaning progress using a verification parameter which is different from the monitoring parameter.

In a development of the invention, the flowmeter is further designed to acquire density measurement values of a medium guided in the measurement tube, wherein the verification parameter comprises a function of at least one density measurement value for at least one reference medium with a known reference density, to which the measurement tube is subjected after the cleaning process has been terminated.

In a development of the invention, the reference medium comprises air and/or water.

In a development of the invention, the monitoring parameter comprises a damping of a measurement tube oscillation.

In a development of the invention, the monitoring parameter comprises the natural frequency of a torsional oscillation of the measurement tube.

In a development of the invention, the flowmeter remains operationally installed in a measurement point in a process system during the cleaning process, in which measurement point the coating to be removed by the cleaning process has formed during normal operation of the process system, wherein normal operation is interrupted during the cleaning process, and wherein the flowmeter acquires and outputs measurement data relating to the monitoring parameters and/or verification parameters during the cleaning process.

In a development of the invention, the flowmeter is removed from a measurement point in a process system during the cleaning process, in which measurement point the coating to be removed by the cleaning process has formed during normal operation of the process system; wherein the flowmeter is operationally installed in a pipeline of a cleaning system during the cleaning process and acquires and outputs measurement data relating to the monitoring parameters and/or verification parameters, in particular outputs them to the cleaning system. Accordingly, according to a development of the invention, the method further comprises removing the flowmeter from a measurement point, mounting the flowmeter in a cleaning system at the beginning of the method and, after the cleaning process, removing the flowmeter from the cleaning system and mounting the flowmeter in the measurement point.

The invention will now be explained in more detail with reference to the exemplary embodiments shown in the figures. in which:

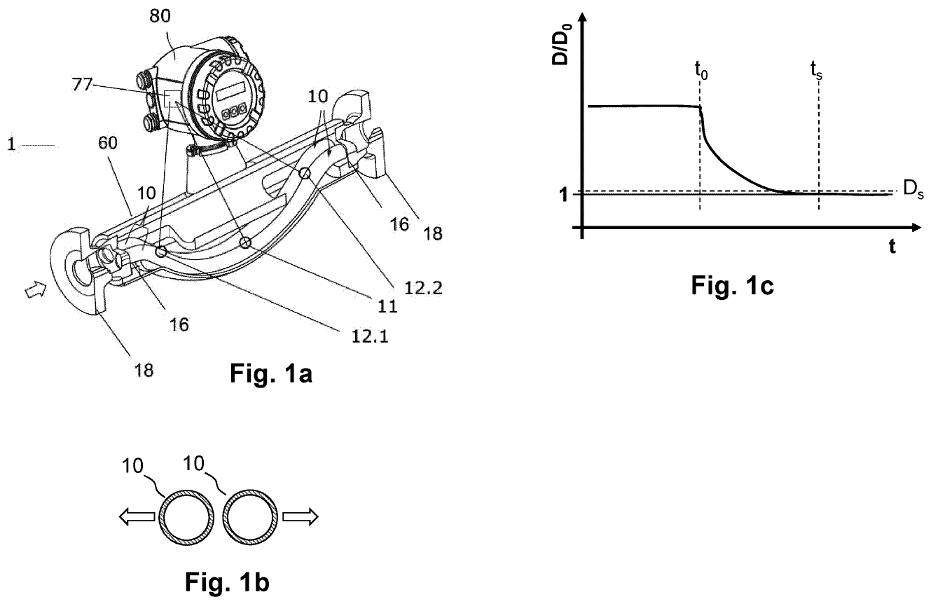

FIG. 1a: an exemplary embodiment of a Coriolis mass flowmeter having a pair of curved measurement tubes;

FIG. 1b: a schematic representation of a relative movement of the measurement tubes of the Coriolis mass flowmeter from FIG. 1a, which they perform during oscillations in the bending oscillation use mode;

FIG. 1c: a schematic diagram of the course of a first monitoring parameter during the implementation of a first exemplary embodiment of the method according to the invention;

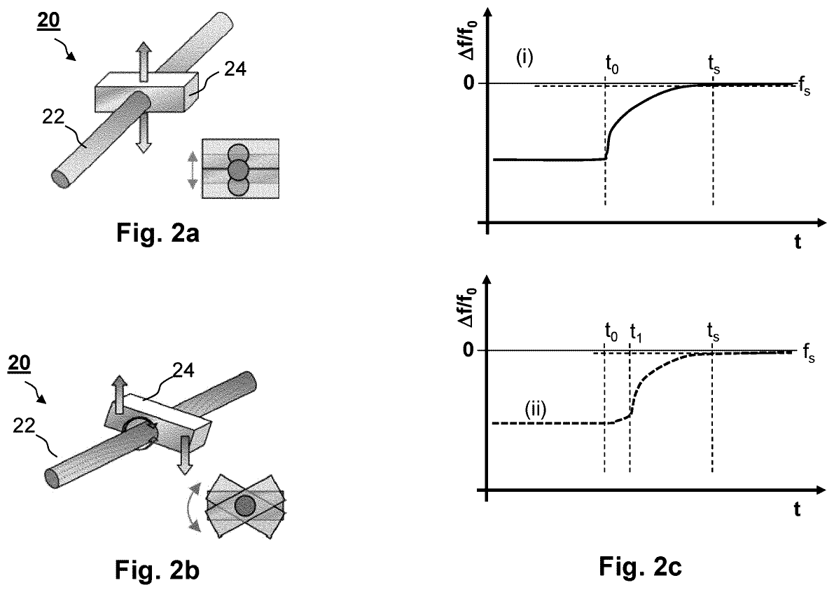

FIG. 2a: a schematic representation of a torsional oscillation of a measurement tube of a Coriolis mass flowmeter having only one straight measurement tube;

FIG. 2b: a schematic representation of a bending oscillation of a measurement tube of a Coriolis mass flowmeter having only one straight measurement tube;

FIG. 2c: a schematic diagram having two courses of a second monitoring parameter during the implementation of a second exemplary embodiment of the method according to the invention;

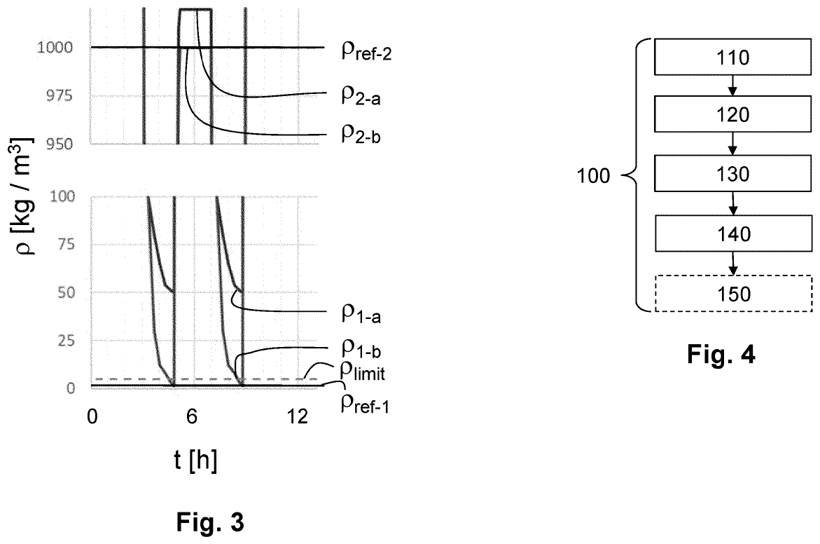

FIG. 3: a schematic diagram of measurement data of a verification parameter:

FIG. 4: a flowchart of an exemplary embodiment of the method according to the invention:

The meter 1 shown in FIG. 1a is a density meter and a Coriolis mass flowmeter. It comprises an oscillator having substantially parallel, curved measurement tubes 10, as well as an exciter 11 which acts between the measurement tubes 10 in the direction of flow in order to excite them to bending oscillations counter to one another. Furthermore, the flowmeter 1 comprises two oscillation sensors 12.1, 12.2, which are arranged symmetrically in the longitudinal direction relative to the center of the measurement tubes 10 in order to detect the relative movement of the measurement tubes 10 oscillating counter to one another. The measurement tubes 10 extend between two flow dividers 16, which fluidically combine the measurement tubes 10 and are each connected to a flange 18, which is used to install the flowmeter 1 in a pipeline. A rigid support tube 60 which connects the flow dividers to one another extends between said flow dividers 16 in order to suppress oscillations of the flow dividers 16 counter to one another in the frequency range of the bending oscillation modes of the measurement tubes 10 counter to one another. The support tube can furthermore carry an electronics housing 80 in which a measurement and operating circuit 77 is contained, which is designed to operate the meter and to carry out the method according to the invention. The exciter 11 and the oscillation sensors 12 are designed in particular as electrodynamic transducers, each of which has an excitation magnet or sensor magnet, and an excitation coil or sensor coil, which are mechanically connected opposite one another to one of the measurement tubes 10. The excitation coil is designed to be supplied by the operating circuit 77 with an alternating current, the frequency of which corresponds to the instantaneous natural frequency of a bending oscillation mode to be excited. Accordingly, the relative movements of the sensor magnets oscillating with the oscillatory measurement tubes 10 relative to the sensor coils induce a voltage in the sensor coils, which depends in particular on the relative velocity of the measurement tubes relative to one another.

The measurement and operating circuit 77 is designed to acquire and evaluate the induced voltages in order to determine therefrom the relative velocities or the deflection of the oscillation sensors 12.1, 12.2 and the measurement tubes 10 connected thereto. The oscillation amplitude of a resonance oscillation of the measurement tubes depends, for a given excitation power, on the quality of the oscillator formed by the measurement tubes 10, wherein the quality is affected by a damping D of the measurement tubes 10, and wherein the damping increases with increasing coating on the wall of the measurement tubes 10. The measurement and operating circuit 77 is further designed to determine damping measurement values on the basis of a relationship between excitation current and oscillation amplitude. In addition, the measurement and operating circuit is designed to determine density measurement values on the basis of the natural frequency of at least one bending oscillation mode. Finally, the operating circuit is designed to monitor the measurement tubes for coatings. This includes, for example, detecting a coating on the basis of damping measurement values and recording the thickness thereof and/or detecting a coating in the event of deviations from density measurement values or deviations from reference densities.

The curve in FIG. 1c shows the course of the damping measurement values D acquired and output by the flowmeter in relation to the damping reference value Do of coating-free measurement tubes during the cleaning process as a function of time t. The damping measurement values serve as monitoring parameters for the cleaning process. The displayed course can extend over a plurality of hours up to a day. At time t₀, at the point at which a cleaning fluid is applied to the measurement tube, the damping is significantly increased, but soon begins to decrease due to the cleaning effect. If the damping measurement values D approach the damping reference value Do up to a threshold Dₛ and/or no further changes in the damping measurement values can be detected, the application of the cleaning agent is terminated at time tₛ. The flowmeter is then rinsed, in particular with water. If necessary, the cleaning result will be verified, as explained below.

FIGS. 2a and 2b show the oscillation modes of a measurement tube 22 of a Coriolis mass flowmeter 22 having a single straight measurement tube 22. Such devices are manufactured and marketed by the applicant under the name Promass I. The bending oscillation mode shown in FIG. 2a does not bring any aspects in the context of the present invention beyond the first exemplary embodiment discussed above. More interesting here is the torsional oscillation shown in FIG. 2b, because in this oscillation mode the measurement tube moves around the medium without accelerating the medium significantly. This means that the natural frequency of the torsional oscillation is largely independent of the density of a medium located in the measurement tube; instead, it is determined by the moment of inertia of a mass body 24 and the moment of inertia of the measurement tube, wherein the moment of inertia of the measurement tube increases with adhering coating of the measurement tube. This means that the natural frequency of the torsional oscillation decreases as the coating grows.

The curves in FIG. 2c therefore show two courses of deviations from the natural frequency Δf of the torsional mode acquired and output by a flowmeter having a measurement tube according to FIGS. 2a and 2b in relation to the reference natural frequency f₀ of the torsional mode for a coating-free measurement tube during the cleaning process as a function of time t. The frequency deviations serve as monitoring parameters for the cleaning process. The displayed courses can extend over a plurality of hours up to a day. At time t₀, at the point at which a cleaning fluid is applied to the measurement tube, the frequency is clearly too low in both cases due to the additional mass of the coating, but soon begins to increase in the first course (i) shown in the diagram above due to the cleaning effect. If the frequency measurement values f have approached the reference natural frequency f₀ up to a threshold value fₛ, i.e. if the frequency deviation Δf practically reaches zero and/or no more changes in the frequency measurement values can be detected, the application of the cleaning agent is terminated at time tₛ. The flowmeter is then rinsed, in particular with water. If necessary, the cleaning result will be verified, as explained below.

A further advantage of the invention becomes clear from the second course (ii) shown below in FIG. 2c. It can be seen that immediately after time t₀, at which a cleaning fluid was applied to the measurement tube, the frequency changed only slowly, i.e. the cleaning process was carried out too slowly. Therefore, at time t₁ the composition of the cleaning agent was changed, after which the cleaning process proceeded at the desired speed. The method according to the invention thus provides the basis for targeted intervention in the cleaning process.

In order to verify the cleaning progress, after the measurement tube(s) have been applied with a cleaning agent and subsequently rinsed, a density measurement of a reference medium of known reference density can be carried out, which can in particular include air or water with reference densities of ρ_{ref-1}=1000 kg/m³ and ρ_{ref-2}=1.2 kg/m³.

On the basis of such a density measurement, a relative mass coating value Mb can be determined according to:

$${M}_{b} = {ρ}_{b} \cdot \frac{d}{r} \approx \frac{{ρ}_{i} - {ρ}_{r e f - i}}{2} . \qquad ( 1 )$$

If this value falls below a process-dependent limit value, the measurement tube can be considered coating-free.

Based on the determination of two density measurement values ρ₁, β₂ with two reference media of known reference density ρ_{ref-1}, ρ_{ref-2}, a coating density value pb can be determined according to:

$${ρ}_{b} = \frac{( {ρ}_{1} - {ρ}_{ref - 1} ) \cdot {ρ}_{ref - 2} - ( {ρ}_{2} - {ρ}_{ref - 2} ) \cdot {ρ}_{ref - 1}}{( {ρ}_{1} - {ρ}_{ref - 1} ) - ( {ρ}_{2} - {ρ}_{ref - 2} )} \qquad ( 2 )$$

and the ratio d/r of an average covering thickness d to the radius r of the measurement tube can be determined according to:

$$\frac{d}{r} = \frac{1}{2} ( 1 - \frac{{ρ}_{1} - {ρ}_{2}}{{ρ}_{ref - 1} - {ρ}_{ref - 2}} ) \qquad ( 3 )$$

FIG. 3 shows data of corresponding density measurements before and after the cleaning process. A density of ρ₂₋ₐ=1020 kg/m³ was determined for water before the cleaning process, while the corresponding value for air was ρ₁₋ₐ=50 kg/m³. After the cleaning process, the following values were obtained: ρ_{2-b}=1000 kg/m³ for water and ρ_{1-b}=2.6 kg/m³ for air.

Using the above measurement and reference values as well as equations 2 and 3, a relative coating thickness of d/r=1.4% can be estimated for the condition before the cleaning process, wherein a value of ρb=1693 kg/m³ results for the coating density.

With the small deviation between the measured density and the reference density observed after the cleaning process, it can substantially be concluded that the measurement tube is practically coating-free. A covering density can also no longer be determined meaningfully. In fact, if the density is found to be below a limit density ρₗᵢₘᵢₜ, which here is 5 kg/m³, it can be concluded that the measurement tube is practically coating-free.

FIG. 4 shows once again, in summary, the method steps of an exemplary embodiment of the present invention:

The method (100) for cleaning a flowmeter comprising at least one oscillatory measurement tube comprises:
applying (110) a cleaning medium to the measurement tube;
repeatedly acquiring (120) measurement values of a monitoring parameter which is dependent on the coating, wherein the measurement values are acquired by means of the meter;
determining (130) a cleaning progress on the basis of the measurement values of the monitoring parameter, which, as explained, may include, for example, a damping or a torsional mode natural frequency.

Controlling (140) the cleaning process may require the termination thereof or changes, for example, to the formulation if the desired cleaning progress is not achieved.

Finally, in an optional step 150, the cleaning measurement can be verified by a density measurement.

1-12. (canceled)

13. A method for cleaning a flowmeter comprising at least one oscillatory measurement tube, wherein the cleaning is performed in order to remove a coating from a wall of the at least one measurement tube, wherein the method comprises:
applying a cleaning medium to the measurement tube;
repeatedly acquiring measurement values of a monitoring parameter which is dependent on the coating, wherein the measurement values are acquired by means of the meter; and
determining a cleaning progress on the basis of the measurement values of the monitoring parameter.

14. The method according to claim 13, wherein determining the cleaning progress comprises:
comparing the measurement values with at least one threshold value of the monitoring parameter; and/or comparing the temporal change in the measurement values with at least one threshold value.

15. The method according to claim 13, further comprising:
controlling the cleaning process on the basis of the determined cleaning progress.

16. The method according to claim 15, wherein controlling the cleaning process comprises:
initiating a subsequent method step on the basis of the cleaning progress.

17. The method according to claim 16, wherein the subsequent method step comprises adjusting a cleaning process with regard to the process parameters thereof and/or terminating the cleaning process.

18. The method according to claim 13, further comprising:
verifying the cleaning progress using a verification parameter which is different from the monitoring parameter.

19. The method according to claim 18, wherein the flowmeter is further designed to acquire density measurement values of a medium guided in the measurement tube, wherein the verification parameter comprises a function of at least one density measurement value for at least one reference medium with a known reference density, to which the measurement tube is subjected after the cleaning process has been terminated.

20. The method according to claim 19, wherein the reference medium comprises air and/or water.

21. The method according to claim 13, wherein the monitoring parameter comprises a damping of a measurement tube oscillation.

22. The method according to claim 13, wherein the monitoring parameter comprises the natural frequency of a torsional oscillation of the measurement tube.

23. The method according to claim 13, wherein the flowmeter remains operationally installed in a measurement point in a process system during the cleaning process, in which measurement point the coating to be removed by the cleaning process has formed during normal operation of the process system, wherein normal operation is interrupted during the cleaning process, and wherein the flowmeter acquires and outputs measurement data relating to the monitoring parameters and/or verification parameters during the cleaning process.

24. The method according to claim 13, wherein the flowmeter is removed from a measurement point in a process system during the cleaning process, in which measurement point the coating to be removed by the cleaning process has formed during normal operation of the process system; wherein the flowmeter is operationally installed in a pipeline of a cleaning system during the cleaning process and acquires and outputs measurement data relating to the monitoring parameters and/or verification parameters, in particular outputs them to the cleaning system.
